(19) United States
(12) Patent Application Publication
(10) Pub. No.: US 2026/0266448 A1
(43) Pub. Date: Sep. 10, 2026

(54) MAGNETIC RETENTION SYSTEM

(71) Applicant: NAIROBI INCORPORATED, Scottsdale, AZ (US)

(72) Inventors: JUSTIN EUGENE EVANS, New Taipei City (TW); SHUAIB NASEEM BADAT, CAPE TOWN (ZA)

(21) Appl. No.: 19/070,747

(22) Filed: Mar. 5, 2025

(51) Int. Cl. F21V 19/00; F21V 23/00; F21V 29/70; F21Y 115/10

(52) U.S. Cl. CPC F21V 19/0015; F21V 23/005; F21V 29/70; F21Y 2115/10

(57) ABSTRACT

A lighting device includes a magnetic retention system for securing a light-emitting device. The device comprises a first structure configured to hold the light-emitting device and a second structure, such as a housing, to which the first structure is magnetically coupled. A first magnetic material is coupled to the first structure, and a second magnetic material is coupled to the second structure, wherein the second magnetic material attracts the first magnetic material to removably couple the first structure to the second structure. In some embodiments, the lighting device includes an LED-COB, a heat sink in thermal communication with the LED-COB, a fan, and a PCB assembly configured to control functionality. The system may incorporate ferrite elements or multiple magnets to improve retention.

### FIELD

Embodiments of the invention generally relate to systems and methods for retaining devices. More specifically, embodiments of the invention concern system and methods for facilitating the retention, removability, and maintenance of an electromagnetic radiation source.

### BACKGROUND

In known lighting systems, light emitting diodes (LEDs) are typically permanently soldered to their substrate, often referred to as a printed circuit board (PCB) or metal core printed circuit board (MCPCB). The substrate is electrically powered to cause the LEDs thereon to illuminate. These light emitting diode-chip on board (LED-COB) devices are typically incorporated in permanent housings, for example, streetlights, movie lights, light bulbs, etc. As a result, when the LEDs fail, the entire lighting system is thrown away. This is somewhat analogous to disposing of an entire lamp every time a light bulb fails.

U.S. Patent Number 11,041,615 B2 allows for the maintenance and replacement of a LED-COB by removing a set of fasteners. The tightening of the fasteners have caused many challenges such as the over-tightening which causes thread-stripping or damage to the fasteners, or under-tightening which causes poor electrification and poor thermal transfer of the system.

Therefore, there is still a need in the relevant technology for systems and methods that facilitate the maintenance and replacement of sources of electromagnetic radiation.

### SUMMARY OF THE INVENTION

In one aspect, the invention concerns an apparatus having a first disk and a second disk; an electromagnetic radiation source placed between the first and second disks; at least a first magnet coupled to the second disk; and at least a second magnet configured to attract the first magnet to facilitate retaining the second disk in a housing of the apparatus. In one embodiment, the first and second disks are configured to receive and retain the electromagnetic radiation source. In some embodiments, the first and second disks are welded together. In certain embodiments, the first and second disks are configured to provide a clearance gap between the first and second disks and the housing of the apparatus. In one embodiment, the electromagnetic radiation source comprises a LED-COB.

In one embodiment, the apparatus can also include at least a third magnet configured to cooperate with the second magnet to enhance the retention of the second disk in the housing of the apparatus. In some embodiments, the second disk has at least one pocket configured to receive and retain the second magnet.

In another aspect, the invention is directed to a lighting apparatus having a first disk and a second disk; a light-emitting device placed between the first and second disks; at least one ferrite element coupled to the second disk; and at least one magnet configured to cooperate with the at least one ferrite element to facilitate retaining the second disk within a housing of the lighting apparatus. In one embodiment, the first disk is configured to partially receive and retain the light-emitting device. In some embodiments, the second disk is configured to partially receive, locate, and retain the light emitting-device.

In certain embodiments, the first and second disks are welded to each other. In one embodiment, the second disk includes a recess to receive and retain the light-emitting device. In some embodiments, the second disk includes a magnet pocket configured to receive and retain the at least one ferrite element. In certain embodiments, the apparatus further includes at least one auxiliary magnet configured to cooperate with the at least one magnet to enhance the retention of the second disk. In one embodiment, the at least one auxiliary magnet is smaller than the at least one magnet. In some embodiments, the second disk comprises an aperture configured to facilitate thermal communication between the light-emitting device and a heat sink.

Yet another aspect of the invention relates to a lighting system having a first disk and a second disk; a LED-COB placed between the first and second disks; a first set of magnets coupled to the second disk; a second set of magnets configured to cooperate with the first set of magnets to facilitate retaining the second disk within a housing of the lighting system; a heat sink in thermal communication with the LED-COB; a fan configured to dissipate heat away from the LED-COB; and a PCB assembly configured to control at least some functionality of the LED-COB.

In one embodiment, the first disk is configured to, at least partially, receive and retain the LED-COB. In some embodiments, the second disk is configured to, at least partially, receive and retain the LED-COB. In certain embodiments, the lighting system further includes a third set of magnets configured to cooperate with the second set of magnets to enhance the retaining of the second disk within the housing of the lighting system. In one embodiment, the second disk has a plurality of magnet pockets configured to receive the second set of magnets. In some embodiments, the housing of the lighting system is configured to receive and retain the second set of magnets.

In yet another aspect, the invention is directed to a lighting device having a first structure configured to hold a light-emitting device; at least one first magnetic material coupled to the first structure; a second structure; at least one second magnetic material coupled to the second structure; and wherein the second magnetic material is configured to attract the first magnetic material to removably couple the first structure to the second structure.

In one embodiment, said lighting device is configured to facilitate connecting the light-emitting device to a circuit board via pogo pins, and the first and second magnetic materials are configured to align the first structure relative to the second structure such that the pogo pins compress by a predetermined amount when the first structure is secured. In some embodiments, the first and second magnetic materials are configured to directly or indirectly urge at least a part of the light-emitting device against a heat sink, maintaining a spacing to ensure consistent contact between said at least part of the light-emitting device and a thermal paste layer.

Yet another aspect of the invention concerns a method for installing or replacing a light-emitting device in a lighting system. In one embodiment, the method involves positioning a first structure holding the light-emitting device adjacent to a second structure; aligning at least one first magnetic material coupled to the first structure with at least one second magnetic material coupled to the second structure; and removably coupling the first structure to the second structure by magnetic attraction between the first and second magnetic materials, thereby securing the light-emitting device in place.

Yet another aspect of the invention relates to a support structure for a magnetic retention system, the support structure can include a body configured to hold a light-emitting device; at least one first magnetic material coupled to the body; wherein the first magnetic material is configured to interact with a second magnetic material of a separate structure to removably couple the support structure to the separate structure; and wherein the light-emitting device is configured to electrically connect to a power source associated with the second structure.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by reference to the following detailed description when considered in conjunction with the accompanying drawings wherein:

FIG. 1 is a perspective view of a lighting system according to one embodiment of the invention.

FIG. 2 is a top view of the lighting system of FIG. 1.

FIG. 3 is a cross-sectional view A-A of the lighting system of FIG. 1.

FIG. 4 is a detail view C of the cross-sectional view of FIG. 3.

FIG. 5 is a detail view D of the top view of FIG. 2.

FIG. 6 is cross-sectional view B-B of the lighting system of FIG. 1.

FIG. 7 is a detail view E of the cross-sectional view of FIG. 6.

FIG. 8 is a perspective view of certain components of the lighting system of FIG. 1

FIG. 9 is another perspective view of the components of FIG. 8.

FIG. 10 is a perspective view of a lighting system according to another embodiment of the invention.

FIG. 11 is a schematic diagram of a magnetic retention system according to an embodiment of the invention.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing exemplary embodiments in detail, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Traditional lighting systems often rely on screws, clips, or other mechanical fasteners to secure components. Over time, these fasteners can wear out, loosen, or cause damage due to repeated tightening and removal. Certain embodiments of the invention disclosed here eliminate mechanical fasteners entirely, using magnetic retention to secure the light-emitting device. By replacing screws with magnets, some embodiments of the system are more durable and easier to maintain. In certain embodiments of the invention, installation and removal are quick and effortless, reducing both time and effort for maintenance. Unlike traditional fasteners that can place stress on components, the magnetic attachment avoids unnecessary strain, leading to a longer lifespan for a lighting device. In some embodiments, the system also provides a secure yet accessible connection—strong enough to keep the light-emitting device in place but easy enough to remove when needed. Additionally, its modular design makes it ideal for dynamic environments, such as exhibitions, smart homes, or industrial applications, where rapid reconfiguration is beneficial.

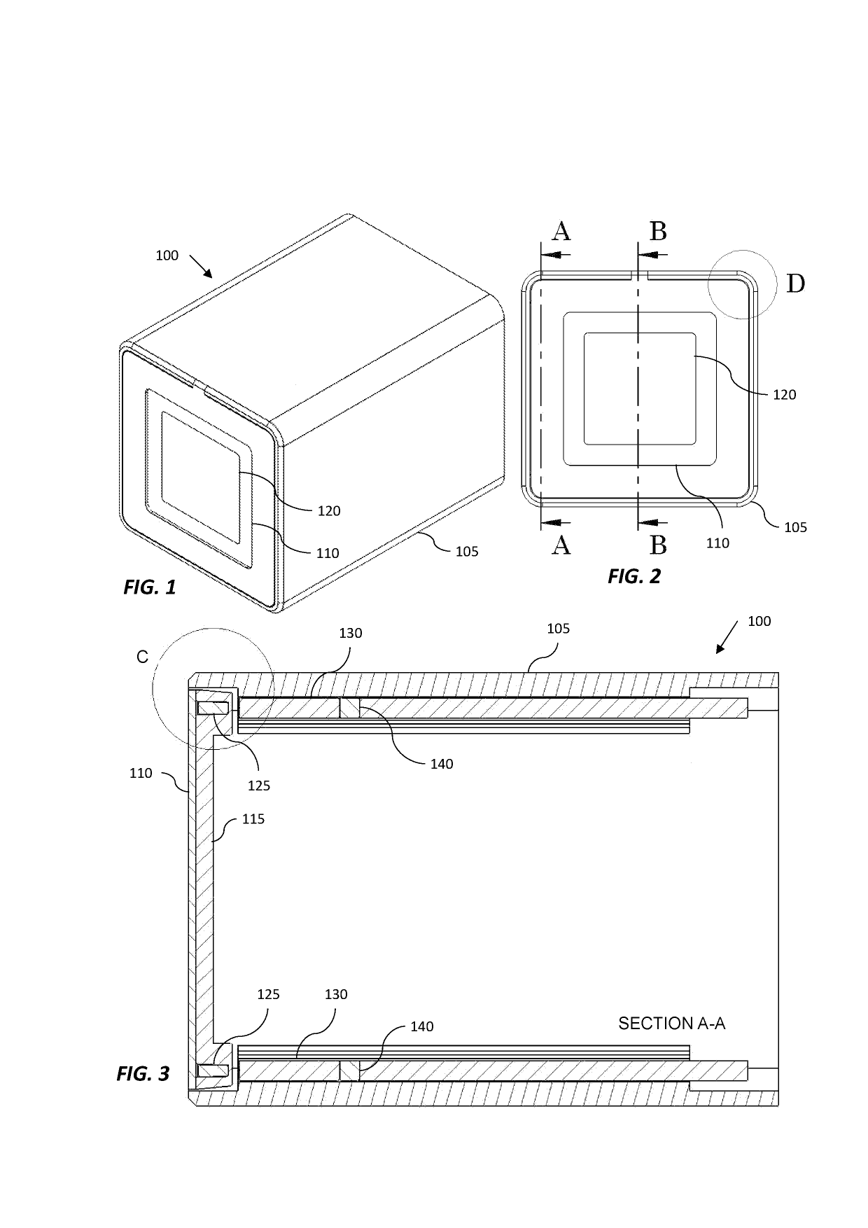

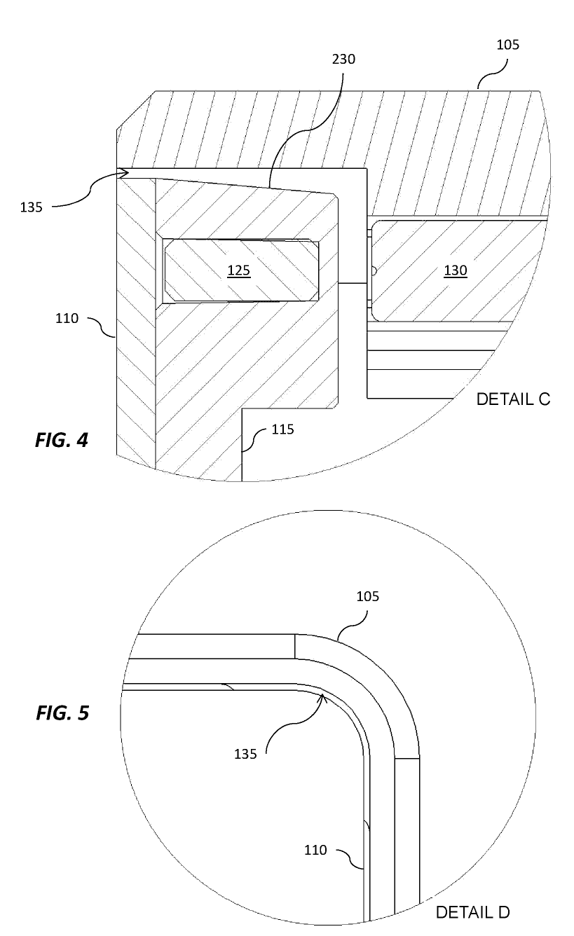

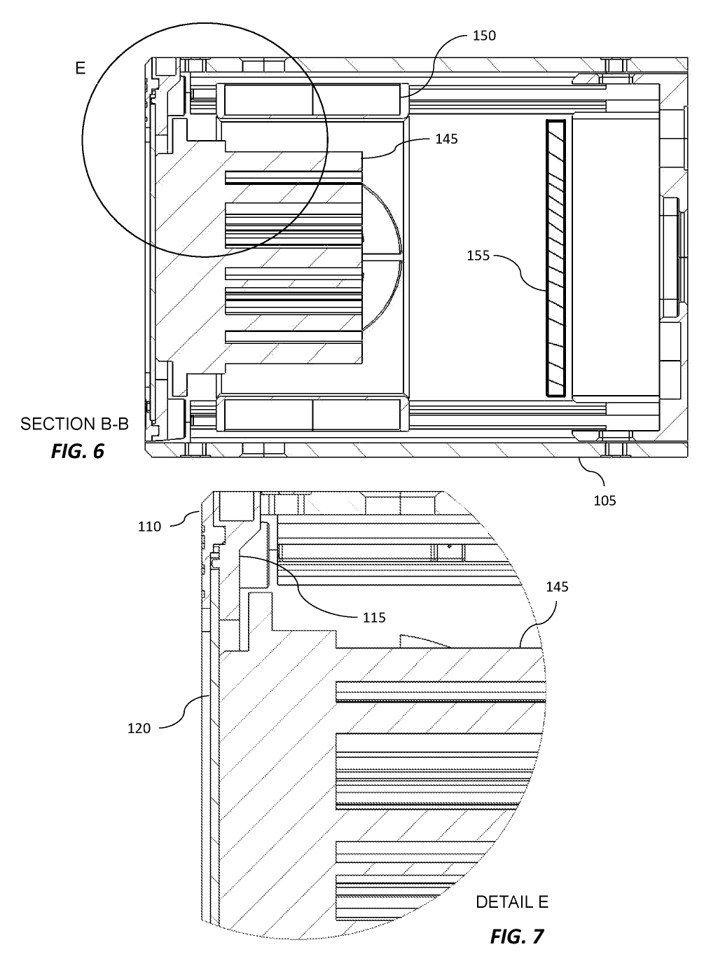

Referencing FIG. 1-7, in one embodiment, lighting system 100 includes housing 105. A first disk 110 and a second disk 115 can be coupled together and can be placed within housing 105. Light emitting device 120 can be placed between first disk 110 and second disk 115. Referencing FIG. 6-7, in some embodiments, light emitting device 120 can be partially received and retained in either or both of first disk 110 and second disk 115. As best shown in FIG. 4-5, in one embodiment, first disk 110 and second disk 115 can be placed within housing 105 while providing clearance gap 135. In some embodiments, first disk 110 and second disk 115 can be ultrasonically welded to each other.

According to one embodiment of the invention, lighting system 100 can include one or more disk magnets 125 coupled to second disk 115. Lighting system 100 can also include housing magnets 130 configured to cooperate with disk magnets 125 to retain second disk 115 within housing 105. In this embodiment, it is unnecessary to use other fastening means, such as screws for example, to retain disk 110, disk 115, or light emitting device 120 within housing 105. In some embodiments, lighting system 100 includes an electrification panel, and second disk 115 is configured to align with pogo pins that provide electrical contact when housing magnets 130 press second disk 115 toward housing 105. This arrangement eliminates the need for wired connections or mechanical compression elements to establish electrical contact. Housing magnets 130 can be coupled to housing 105 through any suitable means known to those of ordinary skill in the art. In some embodiments, lighting system 100 can also include auxiliary magnets 140 configured to cooperate with disk magnets 125 and housing magnets 130 to retain disk 110, disk 115, or light emitting device 120 within housing 105. Given a certain polarity of housing magnets 130, auxiliary magnets 140 can be selected to suitably account for generated torques to thereby produced a greater axial force to attract disk magnets 125 towards housing magnets 130 and auxiliary magnets 140.

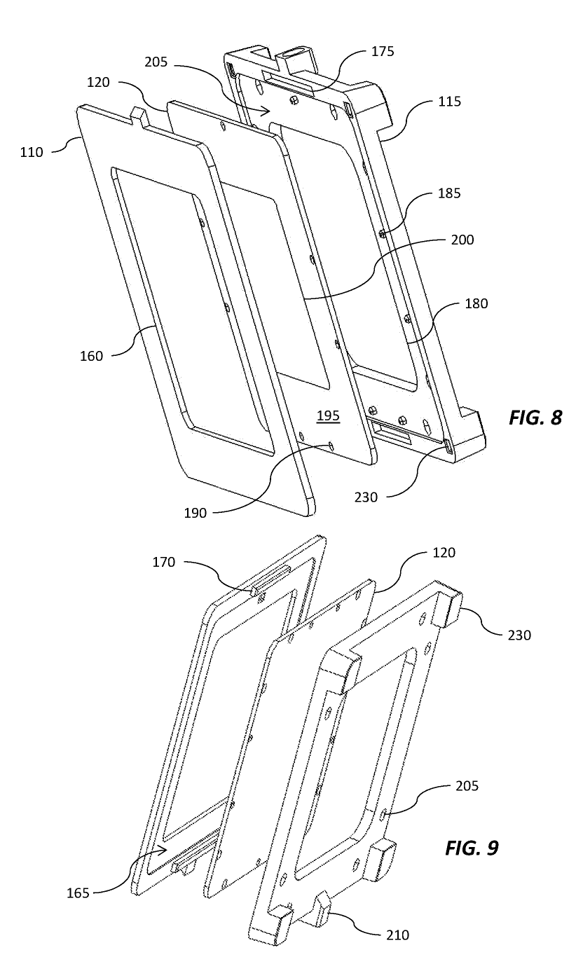

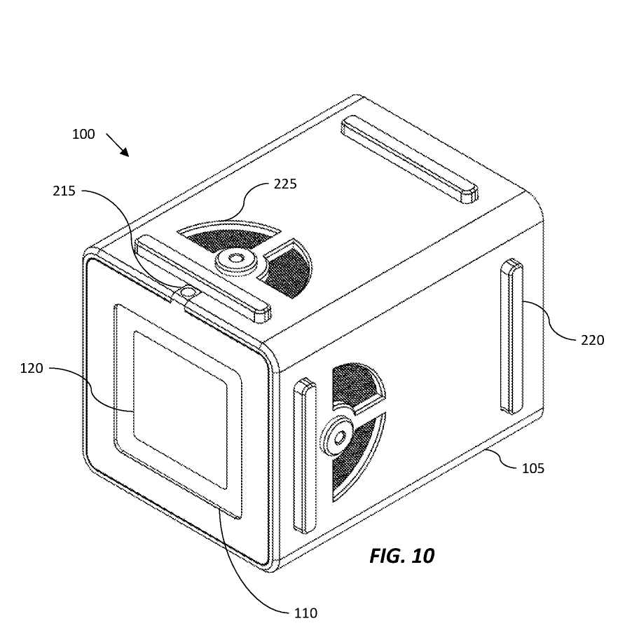

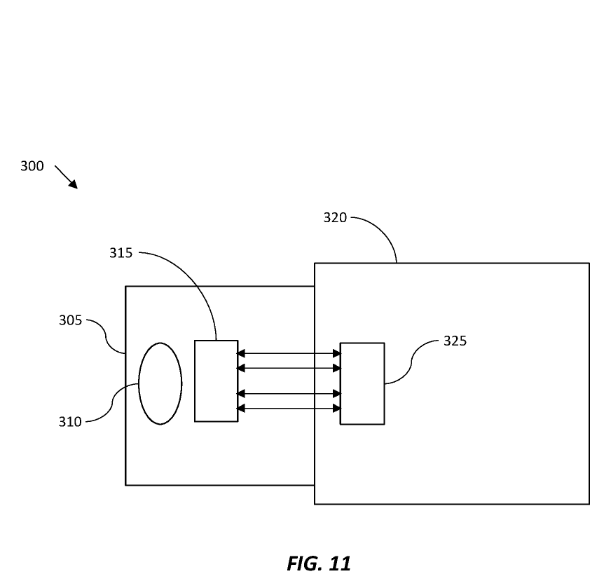

In one embodiment, housing 105 is generally in the shape of rectangular enclosure having four corners. In the embodiments illustrated in FIG. 1, FIG. 8, and FIG. 10, lighting system 100 can include: a) a first set of four disk magnets 125, each disk magnet 125 located at a corner or magnet pocket 230 of second disk 115; b) a second set of four housing magnets 130, each housing magnet 130 located and retained substantially within and at a corner side of housing 105; and a third set of four auxiliary housing magnets 140, each auxiliary housing magnet 140 positioned at a distal end of a corresponding housing magnet 130 (see FIG. 3). In one embodiment, disk magnets 125 can be made of, for example, a ferro-magnetic material. Those of ordinary skill in the art will understand that the arrangement, size, and number of magnets can vary depending on the specific application. It is to be understood that the invention disclosed here is not limited to any one form factor of a lighting system or the number, size, or configuration of the magnets.

Referencing FIG. 6-7, in one embodiment, lighting system 100 can include heat sink 145 in thermal communication with light emitting device 120 to dissipate heat produced by light emitting device 120. Lighting system 100 can also include one or more fans 150 to aid in the dissipation of heat away from housing 105. In certain embodiments, the attractive force generated by the magnetic retention system (that is, the arrangement of disk magnets 125 and housing magnets 130) ensures consistent contact between light emitting device 120 and a thermal paste applied to heat sink 145. In some embodiments due to the strength of the magnetic attraction, only a thin layer of thermal paste is needed to fill any microscopic gaps. This contact facilitates efficient heat transfer and prevents air gaps that could otherwise lead to overheating or system failure. In certain embodiments, lighting system 100 can also include printed circuit board (PCB) assembly 155 suitably connected to light emitting device 120 to control at least some of the functionality of light emitting device 120. In some embodiments, lighting system 100 can include pogo pins configured to provide electrical contact between the LED-COB and a circuit board within housing 105. The magnetic retention system ensures proper alignment of second disk 115 relative to housing 105, allowing the pogo pins to compress by a predetermined amount when second disk 155 is secured. The predetermined amount can be, for example, 50%. This compression maintains reliable electrical contact without requiring additional fasteners or manual adjustments. The predetermined compression may be selected to optimize electrical conductivity and prevent excessive wear on the pogo pins, ensuring consistent operation over repeated attachment and removal cycles. In some embodiments, light emitting device 120 can be, for example, a chip-on-board (COB) light emitting diode (LED) device (LED-COB), edge emitting laser, vertical cavity surface emitting laser (VCSEL), photonic crystal laser diode, or the like. Light emitting device 120 can include chip or core 195 and light emitting diode array 200.

Referencing FIG. 8-9, first disk 110 can include first disk aperture 160 configured to facilitate the emission of light outside lighting system 100 and housing 105 by light emitting device 120. First disk 110 can include first disk recess 165 configured to partially receive or retain light emitting device 120. In some embodiments, first disk 110 can include tongue 170 configured to facilitate location and retention of first disk 110 by mating with groove 175 of second disk 115.

Second disk 115 can include second disk aperture 180 configured to facilitate, among other things, thermal communication between heat sink 145 and light emitting device 120. In certain embodiments, second disk 115 can have second disk recess 205 configured to, at least partially, receive and retain light emitting device 120. In some embodiments, second disk 115 can include locating pegs 185 configured to mate with corresponding locating orifices 190 of light emitting device 120. In one embodiment, second disk 115 can include conductor orifices 205 configured to allow the passage of, for example, conductors (not shown) that connect light emitting device 120 with PCB assembly 155. In some embodiments, second disk 115 can include locating protrusion 210 configured to cooperate with locating slot 215 (see FIG. 10) of housing 105 to facilitate locating and placing second disk 115 in housing 105.

Referencing FIG. 10, in one embodiment, housing 105 can include bumpers 220 coupled to, or formed on, housing 105 to facilitate protection of lighting system 100 from damage by absorbing shocks, and to facilitate handling, storage, and stacking. In certain embodiments, housing 105 can also include suitable cutouts 225 to facilitate air flow from inside housing 105 to the outside of housing 105.

Although not shown, lighting system 100 can include a variety of electrical or mechanical components configured to facilitate the operation of lighting system 100. For example, lighting system 100 can include DMX sockets, an alternating current socket, power switch, spacers, brackets, caps, and fasteners. In one embodiment, for example, housing magnets 130 and auxiliary housing magnets 140 can be retained in housing 105 through a suitable use of brackets, ribs, spacers and/or fasteners.

Referencing FIG. 11, in one embodiment system 300 includes structure 305 configured to hold electromagnetic radiation source 310. One or more pieces of magnetic material 315 can be coupled to structure 305. In one embodiment, system 300 can include structure 320. In certain embodiments, system 300 can include one or more pieces of magnetic material 325 coupled to structure 320. Magnetic material 315 and magnetic material 325 are configured to interact to facilitate removably coupling structure 305 to structure 320 using magnetic attraction, thereby securing electromagnetic radiation source 310 in place. First disk 110 and second disk 115 (FIG. 8), together or singly, are examples of coupling structure 305. In various embodiments, structure 320 may be part of a housing, a frame, or another supporting component of system 300. In one embodiment, system 300 can be a lighting system for use in, for example, lighting applications in the movie industry.

As used here, an electromagnetic radiation source refers to any device that emits electromagnetic radiation as a result of an electrical, chemical, or physical process. This includes, but is not limited to, semiconductor-based electromagnetic emitters, edge-emitting lasers, photonic crystal lasers, light-emitting diodes (LEDs), organic light-emitting diodes (OLEDs), vertical-cavity surface-emitting lasers (VCSELs), lasers, electroluminescent devices, incandescent sources, fluorescent sources, or any solid-state surface-mounted, electromagnetic radiation source component that is affixed to a printed circuit board (PCB) or metal-core printed circuit board (MCPCB).

The shape and configuration of structure 320 may take various forms, including but not limited to cylindrical, spherical, or irregular geometries, as long as it accommodates the components described here. Housing 105 (FIG. 1) is an exemplary embodiment of structure 320. Additionally, certain embodiments of the invention can be implemented with as few as two magnets—one coupled to structure 305 and another coupled to structure 320—while still achieving magnetic retention.

As used here, removably coupling refers to a connection in which a structure is held in place by magnetic attraction but can be detached without tools. In some embodiments, system 300 is configured to removably secure structure 305 to structure 320, such that structure 305 remains stably positioned during operation yet allow for easy removal and reattachment for maintenance or replacement of light-emitting device 310.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible considering the above teachings without departing from the following claims.

1. An apparatus comprising:
a first disk and a second disk;
an electromagnetic radiation source located between the first and second disks;
at least a first magnet coupled to the second disk; and
at least a second magnet configured to attract the first magnet to facilitate retaining the second disk in a housing of the apparatus.

2. The apparatus of claim 1, wherein the electromagnetic radiation source comprises at least one from the group consisting of a semi-conductor based electromagnetic emitter, a light emitting diode-chip on board (LED-COB), an edge emitting laser, a vertical cavity surface emitting laser (VCSEL), and a photonic crystal laser.

3. The apparatus of claim 1, wherein the first and second disks are configured to receive and retain the electromagnetic radiation source.

4. The apparatus of claim 3, wherein the first and second disks are welded together.

5. The apparatus of claim 3, wherein the first and second disks are configured to provide a clearance gap between the first and second disks and the housing of the apparatus.

6. The apparatus of claim 1, further comprising at least a third magnet configured to cooperate with the at least second magnet to enhance the retention of the second disk in the housing of the apparatus.

7. The apparatus of claim 1, wherein the second disk comprises at least one pocket configured to receive and retain the second magnet.

8. An apparatus comprising:
a first disk and a second disk;
a semiconductor-based electromagnetic emitter placed between the first and second disks;
at least one ferrite element coupled to the second disk;
at least one magnet configured to cooperate with the at least one ferrite element to facilitate retaining the second disk within a housing of the apparatus;
wherein the first disk is configured to partially receive and retain the semiconductor-based electromagnetic emitter; and
wherein the second disk is configured to partially receive, locate, and retain the semiconductor-based electromagnetic emitter.

9. The apparatus of claim 8, wherein the semiconductor-based electromagnetic emitter comprises a light emitting diode-chip on board (LED-COB).

10. The apparatus of claim 8, wherein the first and second disks are welded to each other.

11. The apparatus of claim 8, wherein the second disk comprises a recess to receive and retain the semiconductor-based electromagnetic emitter.

12. The apparatus of claim 8, wherein the second disk comprises a magnet pocket configured to receive and retain the at least one ferrite element.

13. The apparatus of claim 8, further comprising at least one auxiliary magnet configured to cooperate with the at least one magnet to enhance the retention of the second disk.

14. The apparatus of claim 8, wherein the second disk comprises an aperture configured to facilitate thermal communication between the semiconductor-based electromagnetic emitter and a heat sink.

15. A lighting system comprising:
a first disk and a second disk;
a LED-COB placed between the first and second disks;
a plurality of first magnets coupled to the second disk;
a plurality of second magnets configured to cooperate with the first magnets to facilitate retaining the second disk within a housing of the lighting system;
a heat sink in thermal communication with the LED-COB;
a fan configured to dissipate heat away from the LED-COB; and
a PCB assembly configured to control at least some functionality of the LED-COB.

16. The lighting system of claim 15, further comprising a plurality of third magnets configured to cooperate with the second magnets to enhance the retaining of the second disk within the housing of the lighting system.

17. The lighting system of claim 15, wherein the housing of the lighting system is configured to receive and retain the plurality of second magnets.

18. A lighting device comprising:
a first structure configured to hold a light-emitting device;
at least one first magnetic material coupled to the first structure;
a second structure;
at least one second magnetic material coupled to the second structure; and
wherein the second magnetic material is configured to attract the first magnetic material to removably couple the first structure to the second structure.

19. The lighting device of claim 18, wherein the lighting device is configured to facilitate connecting the light-emitting device to a circuit board via pogo pins, and wherein the first and second magnetic materials are configured to align the first structure relative to the second structure such that the pogo pins compress when the first structure is secured.

20. A support structure for a magnetic retention system, the support structure comprising:
a body configured to hold a semiconductor-based electromagnetic emitter;
at least one first magnetic material coupled to the body;
wherein the first magnetic material is configured to interact with a second magnetic material of a separate structure to removably couple the support structure to the separate structure; and
wherein the semiconductor-based electromagnetic emitter is configured to electrically connect to a power source associated with the second structure.
